(19) United States
(12) Patent Application Publication
(10) Pub. No.: US 2011/0213743 A1
(43) Pub. Date: Sep. 1, 2011

(54) APPARATUS FOR REALIZING THREE-DIMENSIONAL NEURAL NETWORK

(75) Inventors: Byoung-Gun Choi, Daegu (KR); Sung-Weon Kang, Daejeon (KR); Seok-Bong Hyun, Daejeon (KR); Tae-Young Kang, Seoul (KR); Tae-Wook Kang, Daejeon (KR); Kyung-Soo Kim, Daejeon (KR); Sung-Eun Kim, Seoul (KR); Jung-Bum Kim, Daejeon (KR); JIn-Kyung Kim, Daejeon (KR); Jung-Hwan Hwang, Daejeon (KR); Kyung-Hwan Park, Daejeon (KR); Hyung-Il Park, Daejeon (KR); In-Gi Lim, Daejeon (KR); Chang-Hee Hyoung, Daejeon (KR)

(73) Assignee: ELECTRONICS AND TELECOMMUNICATIONS RESEARCH INSTITUTE, Daejeon (KR)

(21) Appl. No.: 13/127,678

(22) PCT Filed: May 13, 2009
(86) PCT No.: PCT/KR09/02531

§ 371 Date: May 4, 2011

(30) Foreign Application Priority Data
Nov. 4, 2008 (KR) 10-2008-0109082

(51) Int. Cl. G06N 3/04

(52) U.S. Cl. 706/27

(57) ABSTRACT

An apparatus for realizing a three-dimensional (3D) neural network includes a culture substrate (21) having a 3D structure and a plurality of microelectrodes (22) disposed on the culture substrate (21) in such a manner that neurons are cultured with a 3D structure. The central portion of the culture substrate (21) is shaped in a hemispheric form and a peripheral portion is shaped in a planar form. A plurality of outside connection electrodes (23) are disposed on the peripheral portion so as to be connected to an external device, and a plurality of electrode-connecting lines (24) connecting the microelectrodes (22) to the outside connection electrodes (23) are disposed on the culture substrate (21) as well.

### TECHNICAL FIELD

The present application relates to an apparatus for realizing a neural network, and more particularly, to an apparatus for realizing a three-dimensional (3D) neural network, capable of providing parallel operation efficiency comparable to that of a network of neurons of a living creature.

### BACKGROUND ART

Certain ways of thinking and behaviors of humans that at first may look simple and be regarded as natural are carried out in an instant by the pure parallel signal processing of a network of neurons in which nerve impulses pass across synapses between several hundred billions of neurons.

Since signal processing in a computer is enabled by the serial processing of a number of signals between signal-processing elements, there are a number of obstacles in realizing complicated modes of thought or behaviors through the signal processing of a computer.

Even an artificial neural network (or just a “neural network”) resembling the parallel signal processing of brains, is configured in such a manner that unit elements are connected in series. This is different from the pure parallel signal processing of the human network of neurons, and its information processing rate and functions are somewhat limited.

For this reason, many countries, including the USA and members of the EU, are actively carrying out research on a Brain-Machine Interface (BMI) to use a network of neurons of a living creature as an operating part of a computer. In a BMI, a network of neurons is constructed by culturing neurons, and a signal pathway between a neural network and a machine is established via a microelectrode array.

However, since a neural network is constructed by culturing neurons on a planar two-dimensional (2D) culture substrate as shown in FIG. 1, it is difficult to enable effective parallel signal transfer.

Thus, it is practically impossible that neural networks each having a planar 2D structure, as shown in FIG. 1, can obtain parallel operation efficiency comparable to that of a network of neurons of a living creature having a three-dimensional (3D) structure.

### DISCLOSURE OF INVENTION

### Technical Problem

An aspect of the invention provides an apparatus for realizing a three-dimensional (3D) neural network having a 3D structure resembling that of a network of neurons of a living creature such that the 3D neural network can provide parallel operation efficiency comparable to that of the network of neurons of the living creature.

### Technical Solution

According to an aspect of the invention, the apparatus for realizing a 3D neural network may include a culture substrate having a three-dimensional structure; and a plurality of microelectrodes disposed on the culture substrate so that nerve cells are cultured into a three-dimensional structure.

The culture substrate may have a central portion shaped in a hemispherical or spherical form.

The culture substrate may be formed as one substrate having a central portion that is shaped in a spherical form, or as two substrates combined in a face-to-face manner, wherein each of the substrates has a central portion that is shaped in a hemispherical form.

The microelectrodes may be distributed on the central portion of the culture substrate. The microelectrodes may be uniformly distributed on entire regions of the central portion of the culture substrate or differently distributed according to regions of the central portion of the culture substrate.

The apparatus may further include a plurality of outside connection electrodes disposed on two-dimensional peripheral portion of the culture substrate so as to be connected with an external electrode; and a plurality of electrode-connecting lines connecting the microelectrodes to the outside connection electrodes, respectively.

The external device may come into contact with the outside connection electrodes and apply a stimulus to or detect a signal from the neurons through the outside connection electrodes, the electrode-connecting lines and the microelectrodes.

### Advantageous Effects

As set forth above, in the apparatus for realizing a 3D neural network, the microelectrodes are distributed on the culture substrate having a 3D structure, and neurons are allowed to be cultured on the microelectrodes. As a result, the neurons can have a culture structure that resembles that of a network of neurons of a living creature and thereby afford parallel operation efficiency comparable to that of the network of neurons of a living creature.

### BRIEF DESCRIPTION OF DRAWINGS

FIG. 1 illustrates a conventional 2D network of neurons;

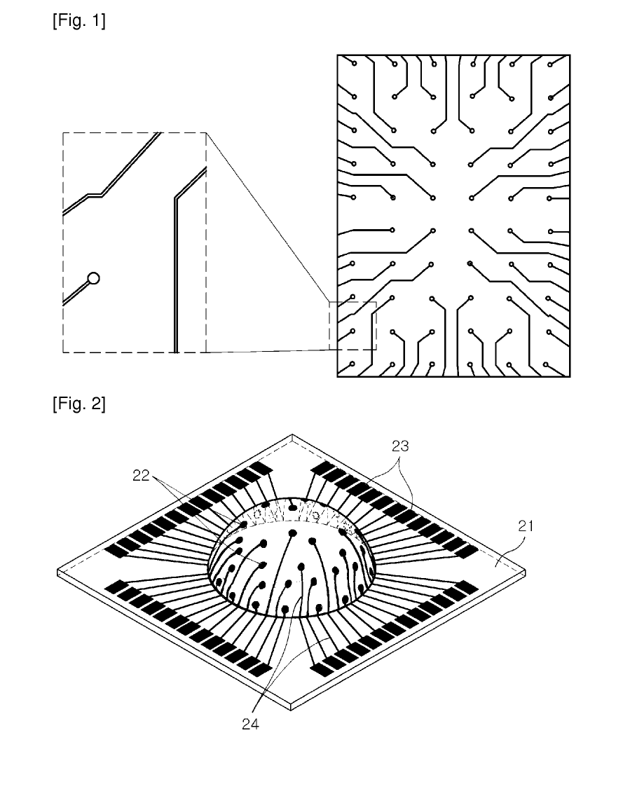

FIGS. 2 through 4 illustrate the structure of an apparatus for realizing a 3D neural network in accordance with an exemplary embodiment of the invention; and

FIGS. 5 and 6 illustrate the structure of an apparatus for realizing a 3D neural network in accordance with another exemplary embodiment of the invention.

### BEST MODE FOR CARRYING OUT THE INVENTION

The present application will now be described more fully hereinafter in conjunction with the accompanying drawings, in which exemplary embodiments thereof are shown, so that this disclosure will be thorough and complete, and will fully convey the scope of the invention to those skilled in the art. In the following description of the present application, a detailed description of known functions and components incorporated herein will be omitted when it may make the subject matter of the present application rather unclear.

Reference should be made to the drawings, from which any parts that are not essential to the present application are omitted for the sake of clarity, and in which the same reference numerals and signs are used throughout the different drawings to designate the same or similar components.

Unless explicitly described to the contrary, the term comprise and variations such as comprises and comprising will be understood to imply the inclusion of stated elements but not the exclusion of any other elements.

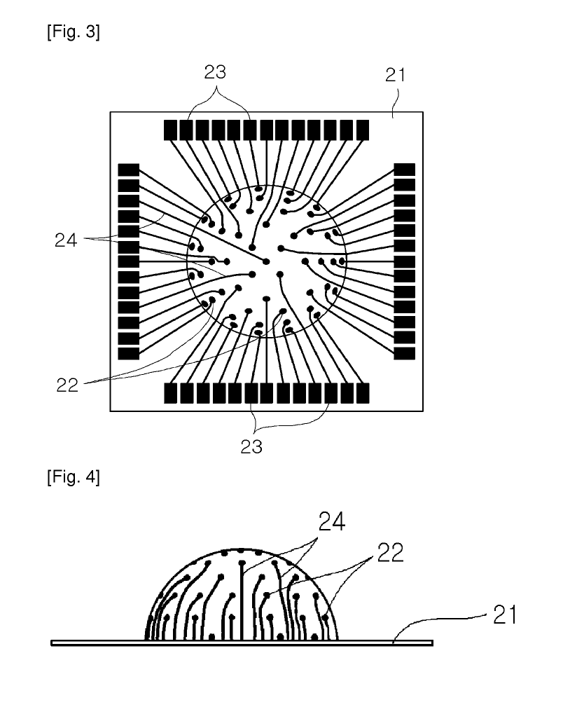

FIGS. 2 through 4 illustrate the structure of an apparatus for realizing a three-dimensional (3D) neural network in accordance with an exemplary embodiment of the invention.

Referring to FIGS. 2 through 4, the apparatus for realizing a 3D neural network includes a culture substrate 21 having a central portion that is shaped in a hemispheric form (i.e. 3D structure) and a peripheral portion that is shaped in a planar form (i.e. 2D structure), a plurality of microelectrodes 22 distributed in the hemispherical central portion of the culture substrate 21, a plurality of outside connection electrodes 23 disposed in line on the peripheral portion of the culture substrate 21 so as to be connected to an external device (not shown), and a plurality of electrode-connecting lines 24 connecting the microelectrodes 22 to the outside connection electrodes 23, respectively. With this construction, nerve cells are cultured on the microelectrodes 22.

As such, the apparatus for realizing a 3D neural network is constructed with the culture substrate 21 having the hemispherical central portion and a plurality of the microelectrodes 22 distributed on the central portion of the culture substrate so as to resemble the configuration of a network of neurons of a living creature.

Since the microelectrodes 22 are disposed on the 3D surface of the culture substrate 21 with a 3D structure, neurons cultured on the microelectrodes 22 also have a 3D structure.

As a result, an external device for stimulating and recording a network of neurons can apply an electric stimulus to or detect an electric signal from the neurons that have a 3D structure, in a fashion similar to that of a network of neurons of a living creature. Accordingly, the neurons can acquire parallel operation efficiency comparable to that of the network of neurons of a living creature.

In this case, the external device brought into contact with the outside connection electrodes 23 stimulates the network of neurons by applying a stimulus to the neurons through the outside connection electrodes 23, the electrode-connecting lines 24 and the microelectrodes 22, or makes a record by detecting a signal from the neurons through the outside the microelectrodes 22, the electrode-connecting lines 24 and the connection electrodes 23.

In addition, although the electrode-connecting lines 24 and the microelectrodes 22 are disposed on the outer surface of the hemispherical portion of the culture substrate 21, it is apparent that they can be disposed on the inner surface of the hemispherical portion of the culture substrate 21.

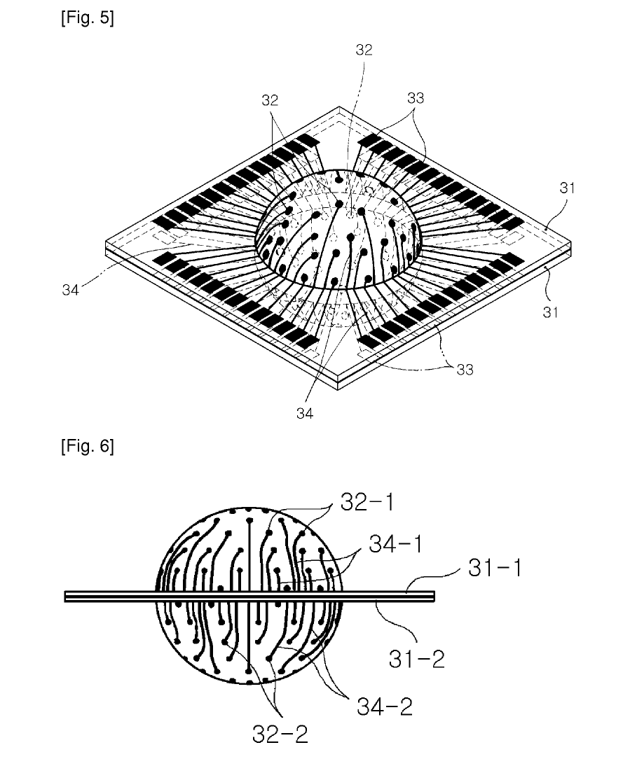

FIGS. 5 and 6 illustrate the structure of an apparatus for realizing a 3D neural network in accordance with another exemplary embodiment of the invention.

Referring to FIGS. 5 and 6, the apparatus for realizing a 3D neural network includes a culture substrate 31 having a central portion that is shaped in a spherical form (i.e. 3D structure) and a peripheral portion that is shaped in a planar form (i.e. 2D structure), a plurality of microelectrodes 32 distributed on the spherical central portion of the culture substrate 31, a plurality of outside connection electrodes 33 disposed in series on the peripheral portion of the culture substrate 31 so as to be connected to an external device, and a plurality of electrode-connecting lines 34 connecting the microelectrodes 32 to the outside connection electrodes 33, respectively. With this construction, nerve cells are cultured on the microelectrodes 32.

The culture substrate 31 can be implemented with one substrate, or by combining two culture substrates 31-1 and 31-2 in a face-to-face manner, wherein each of the culture substrates 31-1 and 31-2 has a hemispherical central portion like the substrate shown in FIG. 2 through FIG. 4.

As such, for the apparatus for realizing a 3D neural network shown in FIGS. 5 and 6, the culture substrate 31 is constructed with a 3D structure like neuron networks of a living creature, but a central portion of the culture 31 is shaped in the spherical formed un like the apparatus for realizing a 3D neural network shown in FIGS. 2 through 4 culture.

Accordingly, the apparatus for realizing a 3D neural network shown in FIGS. 5 and 6 can afford a wider sampling range and more microelectrodes and thus ensure greater parallel processing ability than the apparatus for realizing a 3D neural network shown in FIGS. 2 through 4.

While the embodiments have been described above with respect to a case where the central portion of the culture substrate is configured to be spherical or hemispherical, it will be understood that various changes in form and details may be made to the structure of the culture substrate according to applications and uses of the network of neurons as long as the culture substrate maintains a 3D structure.

In addition, the distribution of the microelectrodes can be modified in various forms. For example, the microelectrodes can be distributed to be uniform along the entire regions of the central portion of the culture substrate 21. Alternatively, the microelectrodes can be distributed differently according to regions of the central portion of the culture substrate 21.

The exemplary embodiments of the present application have been disclosed herein with reference to the drawings. It is to be understood that the terminologies used herein are intended to be in the nature of description rather than of limiting the scope of the present application defined in the claims. Those skilled in the art will understand that many modifications and equivalents are possible in light of the above teachings. Therefore, the scope of the present application shall be defined by the technical idea of the appended claims.

1. An apparatus for realizing a three-dimensional neural network comprising:
a culture substrate having a three-dimensional structure; and
a plurality of microelectrodes disposed on the culture substrate so that nerve cells are cultured into a three-dimensional structure.

2. The apparatus for realizing a three-dimensional neural network of claim 1, wherein the culture substrate has a central portion shaped in a hemispherical or spherical form.

3. The apparatus for realizing a three-dimensional neural network of claim 2, wherein the culture substrate comprises one substrate having a central portion that is shaped in a spherical form.

4. The apparatus for realizing a three-dimensional neural network of claim 2, wherein the culture substrate comprises two substrates combined in a face-to-face manner, wherein each of the substrates has a central portion that is shaped in a hemispherical form.

5. The apparatus for realizing a three-dimensional neural network of claim 2, wherein the microelectrodes are distributed on the central portion of the culture substrate.

6. The apparatus for realizing a three-dimensional neural network of claim 5, wherein the microelectrodes are uniformly distributed on entire regions of the central portion of the culture substrate.

7. The apparatus for realizing a three-dimensional neural network of claim 5, wherein the microelectrodes are differently distributed according to regions of the central portion of the culture substrate.

8. The apparatus for realizing a three-dimensional neural network of claim 2, further comprising:
a plurality of outside connection electrodes disposed on two-dimensional peripheral portion of the culture substrate so as to be connected with an external electrode; and
a plurality of electrode-connecting lines connecting the microelectrodes to the outside connection electrodes, respectively.

9. The apparatus for realizing a three-dimensional neural network of claim 8, wherein the external device comes into contact with the outside connection electrodes and applies a stimulus to or detects a signal from the neurons through the outside connection electrodes, the electrode-connecting lines and the microelectrodes.
